(19) United States
(12) Patent Application Publication
(10) Pub. No.: US 2024/0011705 A1
(43) Pub. Date: Jan. 11, 2024

(54) GAS SEPARATION METHOD USING DEEP COOLING PROCESS

(71) Applicant: BENIT M CO., LTD., Ulsan (KR)

(72) Inventors: Ki Joon KANG, Ulsan (KR); Rionugroho Harvianto GREGORIUS, Ulsan (KR); Kwang Hyun KIM, Ulsan (KR)

(21) Appl. No.: 18/347,710

(22) Filed: Jul. 6, 2023

(30) Foreign Application Priority Data
Jul. 6, 2022 (KR) 10-2022-0083163

(51) Int. Cl. F25J 3/04

(52) U.S. Cl. CPC F25J 3/04406; F25J 3/04866; F25J 3/04048

(57) ABSTRACT

Provided is a gas separation method including: a first process operation including a first freezing operation of blocking a second gas inlet unit, a first transfer operation of sublimating or evaporating the frozen target gas in a second heat exchanger and a first thawing operation of reintroducing the target gas transferred to the second compressor to the second heat exchanger and thawing the second heat exchanger; and a second process operation including a second freezing operation of blocking the first gas inlet unit, a second transfer operation of sublimating or evaporating the frozen target gas in the first heat exchanger and a second thawing operation of reintroducing the target gas transferred to the first compressor to the first heat exchanger and thawing the first heat exchanger, wherein the first process operation is performed for a specified time and then the second process operation is performed for a specified time.

### CROSS-REFERENCE TO RELATED APPLICATION

This application is based on and claims priority under 35 U.S.C. § 119 to Korean Patent Application No. 10-2022-0083163, filed on Jul. 6, 2022, in the Korean Intellectual Property Office, the disclosure of which is incorporated by reference herein in its entirety.

### BACKGROUND

### 1. Field

The disclosure relates to a gas separation method using a deep cooling process, and more particularly, to a gas separation method using a deep cooling process, wherein a target gas is separated from a natural gas, a flue gas, or a synthetic gas by repeatedly freezing and thawing a heat exchanger during the deep cooling process.

### 2. Description of the Related Art

High purity carbon dioxide requires 95% mol or greater or 99.5% mol or greater depending on transportation or a purpose of use.

A natural gas, a flue gas, or a synthetic gas contains carbon dioxide, and a technology of capturing high purity carbon dioxide from the natural gas, the flue gas, or the synthetic gas has been developed.

US 2018-0031315 (published on Feb. 1, 2018) discloses a gas separation method for separating carbon dioxide through a deep cooling process. Referring to US 2018-0031315 (published on Feb. 1, 2018), in a general gas separation method, carbon dioxide is separated by freezing carbon dioxide into solid carbon dioxide through a deep cooling process.

However, when carbon dioxide is separated by freezing carbon dioxide into solid carbon dioxide through the deep cooling process, a mechanical mechanism, such as a scraper or screw, is used to separate solid carbon dioxide frozen on an inner wall of a drum or heat exchanger, and accordingly, a mechanical failure may frequently occur.

Also, solid carbon dioxide discharged through the general gas separation method may absorb moisture from the atmosphere immediately upon the discharge, and thus, moisture concentration may increase, and thus, the solid carbon dioxide may adsorb impurities from the atmosphere. Accordingly, the carbon dioxide concentration may deteriorate.

Accordingly, solid carbon dioxide discharged through the general gas separation method needs to be stored in a container separated from the atmosphere immediately upon the discharge. However, in this case, with respect to solid handling, it is difficult to place solid carbon dioxide in the separate container without being in contact with the atmosphere immediately upon the discharge.

### SUMMARY

Provided is a gas separation method using a deep cooling process, wherein a target gas is separated from a natural gas, a flue gas, or a synthetic gas by repeatedly freezing and thawing a heat exchanger during the deep cooling process.

Additional aspects will be set forth in part in the description which follows and, in part, will be apparent from the description, or may be learned by practice of the presented embodiments of the disclosure.

According to an aspect of the disclosure, a method of separating a gas through a gas separation apparatus for separating a gas by using a deep cooling process, wherein the gas separation apparatus includes: a first heat exchanger for cooling an inlet gas, a first gas inlet unit connected to the first heat exchanger and introducing the inlet gas to the first heat exchanger, and a first circulation pipe for reintroducing a gas discharged from the first heat exchanger to the first heat exchanger and including a first compressor; and a second heat exchanger for cooling the inlet gas, a second gas inlet unit connected to the second heat exchanger and introducing the inlet gas to the second heat exchanger, and a second circulation pipe for reintroducing a gas discharged from the second heat exchanger to the second heat exchanger and including a second compressor, the method includes: a first process operation including a first freezing operation of blocking the second gas inlet unit, introducing the inlet gas to the first heat exchanger through the first gas inlet unit, and freezing a target gas in the first heat exchanger, a first transfer operation of sublimating or evaporating the frozen target gas in the second heat exchanger and transferring the same to the second compressor of the second circulation pipe, and a first thawing operation of reintroducing the target gas transferred to the second compressor to the second heat exchanger and thawing the second heat exchanger; and a second process operation including a second freezing operation of blocking the first gas inlet unit, introducing the inlet gas to the second heat exchanger through the second gas inlet unit, and freezing the target gas in the second heat exchanger, a second transfer operation of sublimating or evaporating the frozen target gas in the first heat exchanger and transferring the same to the first compressor of the first circulation pipe, and a second thawing operation of reintroducing the target gas transferred to the first compressor to the first heat exchanger and thawing the first heat exchanger, wherein the first process operation is performed for a specified time and then the second process operation is performed for a specified time.

The first process operation may be performed again after the second process operation is performed, and the first process operation and the second process operation may be alternately performed.

The target gas may be a sublimating gas.

The target gas may be carbon dioxide.

The first gas inlet unit and the second gas inlet unit may be connected to a compressor.

The first circulation pipe and the second circulation pipe may be connected to each other, and the first compressor and the second compressor may configure one compressor.

A first opening or closing valve for opening or closing the first gas inlet unit may be provided at the first gas inlet unit, and a second opening or closing valve for opening or closing the second gas inlet unit may be provided at the second gas inlet unit.

The first circulation pipe may include a (1-1)th circulation valve for opening or closing the first circulation pipe at a front end of the first compressor, and a (1-2)th circulation valve for opening or closing the first circulation pipe at a rear end of the first compressor, and the second circulation pipe may include a (2-1)th circulation valve for opening or closing the second circulation pipe at a front end of the second compressor, and a (2-2)th circulation valve for opening or closing the second circulation pipe at a rear end of the second compressor.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram of a gas separation apparatus according to an embodiment of the disclosure;

FIG. 2 is a flowchart of a gas separation method using a deep cooling process, according to an embodiment of the disclosure;

FIG. 3 is a diagram of production of hydrates of carbon dioxide containing moisture; and

FIG. 4 is a phase equilibrium diagram of carbon dioxide.

### DETAILED DESCRIPTION

The present specification describes the principles of the disclosure and discloses embodiments of the disclosure such that the scope of right of the disclosure is clarified and one of ordinary skill in the art may practice the disclosure. The embodiments may be implemented in various forms.

The terms such as “include” or “including” that may be used in various embodiments of the disclosure indicate existence of a corresponding function, operation, or component in the disclosure, and do not limit addition of one or more functions, operations, or components. Also, in various embodiments of the disclosure, it may be understood that terms such as “including” or “having”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

When a component is “connected” or “coupled” to another component, it may be understood that the component may be directly connected or coupled to the other component, or a new component may be present between the component and the other component. On the other hand, when a component is “directly connected” or “directly coupled” to another component, it may be understood that there is no new component between the component and the other component.

The terms such as “first”, “second”, etc., used in the present specification may be used to describe various components, but such components must not be limited to the above terms. The above terms are used only to distinguish one component from another.

The disclosure relates to a gas separation method using a deep cooling process, i.e., a gas separation method using a deep cooling process, wherein a target gas is separated from a natural gas, a flue gas, or a synthetic gas by repeatedly freezing and thawing a heat exchanger during the deep cooling process.

The gas separation method using a deep cooling process, according to an embodiment of the disclosure, may be a method of separating carbon dioxide (CO₂) from a natural gas, a flue gas, or a synthetic gas. A target gas that is to be separated during the gas separation method using a deep cooling process, according to an embodiment of the disclosure, may be a carbon dioxide.

In detail, the gas separation method using a deep cooling process, according to an embodiment of the disclosure, is related to a method of separating carbon dioxide mixed with impurities, such as nitrogen, oxygen, carbon monoxide, hydrogen, hydrocarbon, moisture and nitrogen oxide, sulfur oxide, carbonyl sulfide (COS), hydrogen sulfide (H₂S), or carbon disulfide (CO₂), and the gas separation method using a deep cooling process, according to an embodiment of the disclosure, may separate high purity carbon dioxide by repeatedly freezing and thawing a heat exchanger during the deep cooling process.

However, the gas separation method using a deep cooling process, according to an embodiment of the disclosure, is not limited to a method of separating carbon dioxide, and may separate a gas having a similar property as carbon dioxide. Hereinafter, embodiments of the disclosure will be described in detail with reference to the accompanying drawings.

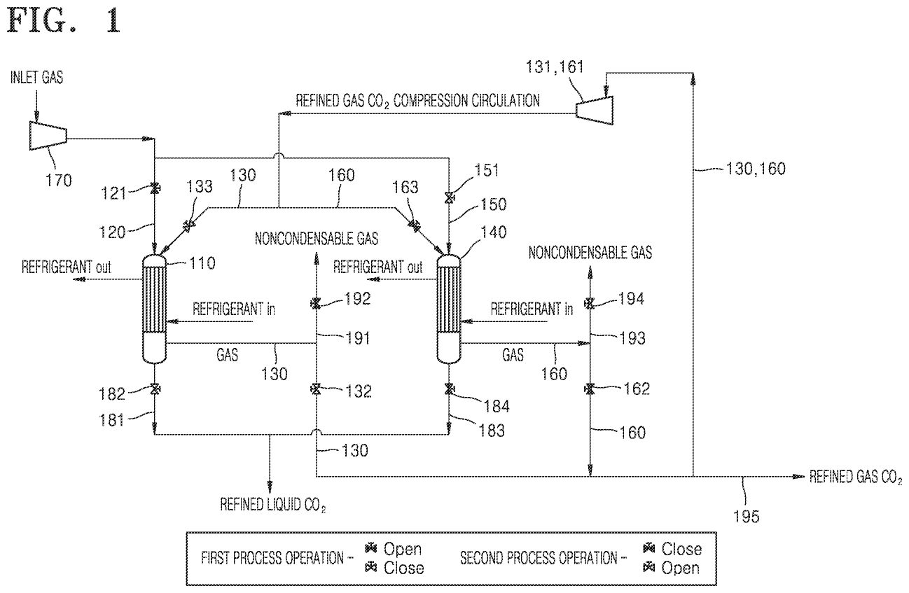

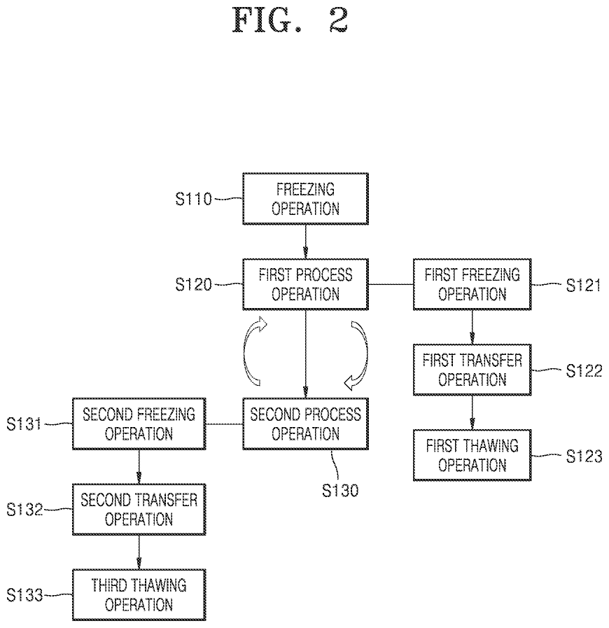

Referring to FIGS. 1 and 2, a gas separation method using a deep cooling process, according to an embodiment of the disclosure, includes a freezing operation (S110), a first process operation (S120), and a second process operation (S130).

The gas separation method using a deep cooling process, according to an embodiment of the disclosure, is a method of separating a gas through a gas separation apparatus for separating a gas by using a deep cooling process, and the gas separation apparatus includes a first heat exchanger 110, a first gas inlet unit 120, a first circulation pipe 130, a second heat exchanger 140, a second gas inlet unit 150, and a second circulation pipe 160.

The first heat exchanger 110 cools down an inlet gas and a refrigerant may be introduced to the first heat exchanger 110. The first heat exchanger 110 may cool down the inlet gas through the refrigerant.

The first gas inlet unit 120 is connected to the first heat exchanger 110 to introduce the inlet gas to the first heat exchanger 110. The first gas inlet unit 120 is a pipe connected to the first heat exchanger 110, and the inlet gas may be introduced to the first heat exchanger 110 through the first gas inlet unit 120.

A first opening or closing valve 121 that opens or closes the first gas inlet unit 120 may be provided at the first gas inlet unit 120. The first gas inlet unit 120 may be opened or closed through the first opening or closing valve 121.

The first circulation pipe 130 reintroduces a gas discharged from the first heat exchanger 110 to the first heat exchanger 110, and includes a first compressor 131. The first circulation pipe 130 is a pipe from which the gas of the first heat exchanger 110 is discharged, and the first circulation pipe 130 may externally extend from one point of the first heat exchanger 110.

After being externally extended from the one point of the first heat exchanger 110, the first circulation pipe 130 may be connected to the first heat exchanger 110 at a point other than the one point of the first heat exchanger 110, and a gas of the first circulation pipe 130 may be reintroduced to the first heat exchanger 110 through the other point of the first heat exchanger 110.

The first circulation pipe 130 may include the first compressor 131, and the first compressor 131 may compress the gas reintroduced to the first heat exchanger 110 from the first circulation pipe 130.

The first circulation pipe 130 may include a (1-1)th circulation valve 132 that opens or closes the first circulation pipe 130 at a front end of the first compressor 131. The first circulation pipe 130 may be opened or closed at the front end of the first compressor 131 through the (1-1)th circulation valve 132, and accordingly, introduction of the gas to the first compressor 131 may be controlled.

The first circulation pipe 130 may include a (1-2)th circulation valve 133 that opens or closes the first circulation pipe 130 at a rear end of the first compressor 131. The first circulation pipe 130 may be opened or closed at the rear end of the first compressor 131 through the (1-2)th circulation valve 133, and accordingly, the reintroduction of the gas to the first heat exchanger 110 may be controlled.

The gas separation apparatus may further include a first gas discharge pipe 191 and a first liquid discharge pipe 181. The first gas discharge pipe 191 is a pipe branched from the first circulation pipe 130 and externally discharges the gas of the first heat exchanger 110.

The first gas discharge pipe 191 may include a first gas discharge valve 192 that opens or closes the first gas discharge pipe 191. The first gas discharge pipe 191 may be opened or closed through the first gas discharge valve 192, and accordingly, the external discharge of the gas of the first heat exchanger 110 may be controlled.

In detail, when the (1-1)th circulation valve 132 included in the first circulation pipe 130 is opened and the first gas discharge valve 192 is closed, the gas of the first heat exchanger 110 may be reintroduced to the first heat exchanger 110 through the first circulation pipe 130.

On the other hand, when the (1-1)th circulation valve 132 included in the first circulation pipe 130 is closed and the first gas discharge valve 192 is opened, the gas of the first heat exchanger 110 may be externally discharged.

The first liquid discharge pipe 181 may externally discharge liquid generated in the first heat exchanger 110. The first liquid discharge pipe 181 may include a first liquid discharge valve 182 that opens or closes the first liquid discharge pipe 181. The first liquid discharge pipe 181 may be opened or closed through the first liquid discharge valve 182, and accordingly, the external discharge of the liquid in the first heat exchanger 110 may be controlled.

The second heat exchanger 140 cools down the inlet gas and the refrigerant may be introduced to the second heat exchanger 140. The second heat exchanger 140 may cool down the inlet gas through the refrigerant.

The second gas inlet unit 150 is connected to the second heat exchanger 140 to introduce the inlet gas to the second heat exchanger 140. The second gas inlet unit 150 is a pipe connected to the second heat exchanger 140, and the inlet gas may be introduced to the second heat exchanger 140 through the second gas inlet unit 150.

A second opening or closing valve 151 that opens or closes the second gas inlet unit 150 may be provided at the second gas inlet unit 150. The second gas inlet unit 150 may be opened or closed through the second opening or closing valve 151.

The second circulation pipe 160 reintroduces a gas discharged from the second heat exchanger 140 to the second heat exchanger 140, and includes a second compressor 161. The second circulation pipe 160 is a pipe from which the gas of the second heat exchanger 140 is discharged, and the second circulation pipe 160 may externally extend from one point of the second heat exchanger 140.

After being externally extended from the one point of the second heat exchanger 140, the second circulation pipe 160 may be connected to the second heat exchanger 140 at a point other than the one point of the second heat exchanger 140, and a gas of the second circulation pipe 160 may be reintroduced to the second heat exchanger 140 through the other point of the second heat exchanger 140.

The second circulation pipe 160 may include the second compressor 161, and the second compressor 161 may compress the gas reintroduced to the second heat exchanger 140 from the second circulation pipe 160.

The second circulation pipe 160 may include a (2-1)th circulation valve 162 that opens or closes the second circulation pipe 160 at a front end of the second compressor 161. The second circulation pipe 160 may be opened or closed at the front end of the second compressor 161 through the (2-1)th circulation valve 162, and accordingly, introduction of the gas to the second compressor 161 may be controlled.

The second circulation pipe 160 may include a (2-2)th circulation valve 163 that opens or closes the second circulation pipe 160 at a rear end of the second compressor 161. The second circulation pipe 160 may be opened or closed at the rear end of the second compressor 161 through the (2-2)th circulation valve 163, and accordingly, the reintroduction of the gas to the second heat exchanger 140 may be controlled.

The gas separation apparatus may further include a second gas discharge pipe 193 and a second liquid discharge pipe 183. The second gas discharge pipe 193 is a pipe branched from the second circulation pipe 160 and externally discharges the gas of the second heat exchanger 140.

The second gas discharge pipe 193 may include a second gas discharge valve 194 that opens or closes the second gas discharge pipe 193. The second gas discharge pipe 193 may be opened or closed through the second gas discharge valve 194, and accordingly, the external discharge of the gas of the second heat exchanger 140 may be controlled.

In detail, when the (2-1)th circulation valve 162 included in the second circulation pipe 160 is opened and the second gas discharge valve 194 is closed, the gas of the second heat exchanger 140 may be reintroduced to the second heat exchanger 140 through the second circulation pipe 160.

On the other hand, when the (2-1)th circulation valve 162 included in the second circulation pipe 160 is closed and the second gas discharge valve 194 is opened, the gas of the second heat exchanger 140 may be externally discharged.

The second liquid discharge pipe 183 may externally discharge liquid generated in the second heat exchanger 140. The second liquid discharge pipe 183 may include a second liquid discharge valve 184 that opens or closes the second liquid discharge pipe 183. The second liquid discharge valve 184 may be opened or closed through the second liquid discharge valve 184, and accordingly, the external discharge of the liquid in the second heat exchanger 140 may be controlled.

The first gas inlet unit 120 and the second gas inlet unit 150 of the gas separation apparatus may be connected to a compressor 170. However, the compressor 170 may or may not be used as needed.

The first circulation pipe 130 and the second circulation pipe 160 of the gas separation apparatus may be connected to each other, and the first compressor 131 and the second compressor 161 may be configured as one compressor.

In detail, the first circulation pipe 130 and the second circulation pipe 160 may be connected to each other while sharing a pipe including compressors (the first compressor 131 and the second compressor 161). When the pipe including the compressors (the first compressor 131 and the second compressor 161) is shared, whether to transfer the gas from the compressors to the first circulation pipe 130 or to the second circulation pipe 160 may be controlled through opening/closing of the (1-2)th circulation valve 133 and (2-2)th circulation valve 163.

Hereinafter, the gas separation method using a deep cooling process, according to an embodiment of the disclosure, using the gas separation apparatus will be described in detail.

FIG. 1 is a diagram for describing a method of separating carbon dioxide (CO₂) from an inlet gas through the gas separation method using a deep cooling process, according to an embodiment of the disclosure, and a target gas to be separated during the gas separation method using a deep cooling process, according to an embodiment of the disclosure, may be carbon dioxide.

However, the disclosure is not limited thereto, and the target gas to be separated during the gas separation method using a deep cooling process, according to an embodiment of the disclosure, may be a sublimated gas. In detail, the target gas may be a gas sublimated at room temperature. The target gas is not limited to a sublimated gas, and may be an evaporated gas.

Hereinafter, the method of separating carbon dioxide from an inlet gas, wherein the target gas is carbon dioxide, as shown in FIG. 1, will be mainly described.

The inlet gas introduced to the gas separation apparatus is a gas in which carbon dioxide is mixed with impurities, such as nitrogen, oxygen, carbon monoxide, hydrogen, hydrocarbon, moisture and nitrogen oxide, sulfur oxide, COS, H₂S, or CS₂.

The inlet gas introduced to the gas separation apparatus may be introduced to one of the first gas inlet unit 120 and the second gas inlet unit 150. In detail, when the first opening or closing valve 121 of the first gas inlet unit 120 is opened and the second opening or closing valve 151 of the second gas inlet unit 150 is closed, the inlet gas may be introduced to the first gas inlet unit 120.

On the other hand, when the first opening or closing valve 121 of the first gas inlet unit 120 is closed and the second opening or closing valve 151 of the second gas inlet unit 150 is opened, the inlet gas may be introduced to the second gas inlet unit 150.

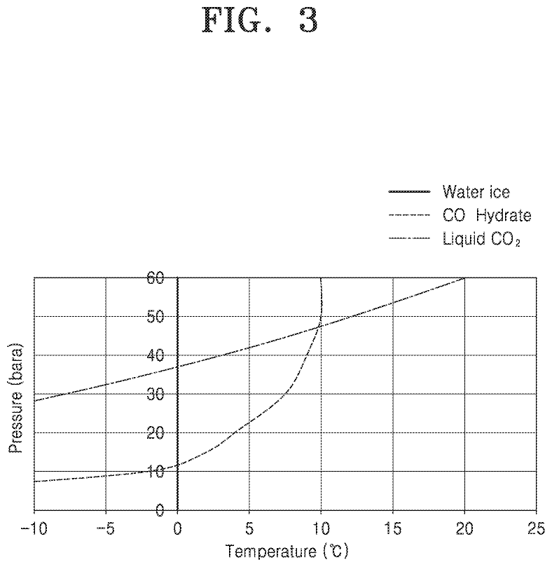

The inlet gas according to an embodiment of the disclosure may be a gas from which moisture has been removed. Referring to FIG. 3, when moisture is mixed with carbon dioxide, carbon dioxide may be frozen at a low temperature or carbon dioxide hydrate (CO₂ hydrate) may be generated, and thus a pipe or apparatus may be blocked. Thus, moisture may be removed before carbon dioxide is removed from the inlet gas.

A process of removing moisture from the inlet gas may include a deep cooling process and may include other processes. Various methods may be applied to the process of removing moisture from the inlet gas, and thus detailed descriptions thereof are omitted.

Referring to FIG. 2, the freezing operation (S110) of the gas separation method using a deep cooling process, according to an embodiment of the disclosure, is a process of freezing the target gas by introducing the inlet gas to the second heat exchanger 140 through the second gas inlet unit 150.

The inlet gas is introduced to the second gas inlet unit 150 by closing the first opening or closing valve 121 of the first gas inlet unit 120 and opening the second opening or closing valve 151 of the second gas inlet unit 150. At this time, the compressor 170 may or may not be connected to the first gas inlet unit 120 and the second gas inlet unit 150.

The refrigerant may be supplied to the second heat exchanger 140, and the target gas among the inlet gas introduced to the second heat exchanger 140 is cooled down to be frozen through the refrigerant.

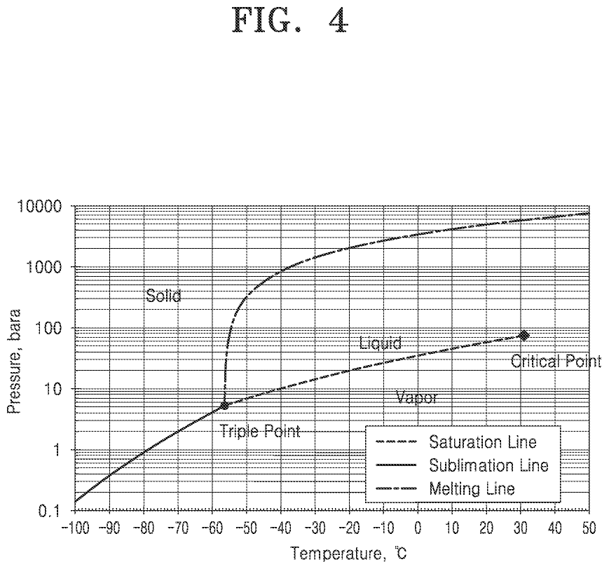

When the target gas is carbon dioxide, the inlet gas is cooled down in the second heat exchanger 140 at a temperature at which solid carbon dioxide is generated, considering a carbon dioxide phase equilibrium diagram of FIG. 4.

In detail, considering pressure inside the second heat exchanger 140, the inlet gas of the second heat exchanger 140 is cooled down through the refrigerant such that solid carbon dioxide is generated in the second heat exchanger 140.

When carbon dioxide is frozen in the second heat exchanger 140, a noncondensable gas from which carbon dioxide has been removed may be externally discharged through the second circulation pipe 160 and second gas discharge pipe 193.

At this time, the second gas discharge valve 194 is opened and the (2-1)th circulation valve 162 is closed. Also, a temperature of the noncondensable gas discharged through the second gas discharge pipe 193 may be equal to or lower than a temperature at which solid carbon dioxide is generated.

After the freezing operation (S110), the first process operation (S120) may be performed. Here, the freezing operation (S110) is an operation in which freezing occurs before the first process operation (S120) and the second process operation (S130), and when the freezing already occurred in the second heat exchanger 140, the freezing operation (S110) may be skipped and the first process operation (S120) and the second process operation (S130) may be performed.

The first process operation (S120) includes a first freezing operation (S121), a first transfer operation (S122), and a first thawing operation (S123).

In the first freezing operation (S121), the second gas inlet unit 150 is blocked and the inlet gas is introduced to the first heat exchanger 110 through the first gas inlet unit 120 so as to freeze the target gas in the first heat exchanger 110.

The inlet gas is introduced to the first gas inlet unit 120 by opening the first opening or closing valve 121 of the first gas inlet unit 120 and closing the second opening or closing valve 151 of the second gas inlet unit 150. At this time, the compressor 170 may or may not be connected to the first gas inlet unit 120 and the second gas inlet unit 150.

The refrigerant may be supplied to the first heat exchanger 110, and the target gas among the inlet gas introduced to the first heat exchanger 110 is cooled down to be frozen through the refrigerant.

When the target gas is carbon dioxide, the inlet gas is cooled down in the first heat exchanger 110 at a temperature at which solid carbon dioxide is generated, considering the carbon dioxide phase equilibrium diagram of FIG. 4.

In detail, considering pressure inside the first heat exchanger 110, the inlet gas of the first heat exchanger 110 is cooled down through the refrigerant such that solid carbon dioxide is generated in the first heat exchanger 110.

When carbon dioxide is frozen in the first heat exchanger 110, a noncondensable gas from which carbon dioxide has been removed may be externally discharged through the first circulation pipe 130 and first gas discharge pipe 191.

At this time, the first gas discharge valve 192 is opened and the (1-1)th circulation valve 132 is closed. Also, a temperature of the noncondensable gas discharged through the first gas discharge pipe 191 may be equal to or lower than a temperature at which solid carbon dioxide is generated.

In the first transfer operation (S122), the target gas frozen in the second heat exchanger 140 is sublimated or evaporated, and transferred to the second compressor 161 of the second circulation pipe 160. The freezing has occurred in the second heat exchanger 140 during the freezing operation (S110), and thus the target gas is frozen in the second heat exchanger 140.

In the first transfer operation (S122), the target gas frozen in the second heat exchanger 140 is sublimated or evaporated (or liquefied) through the refrigerant, and the target gas sublimated or evaporated in the first transfer operation (S122) may be transferred to the second compressor 161 through the second circulation pipe 160.

In detail, when the target gas is carbon dioxide, carbon dioxide frozen in the second heat exchanger 140 may be sublimated or evaporated by the refrigerant, and sublimated or evaporated carbon dioxide may be transferred to the second compressor 161 through the second circulation pipe 160. (A temperature and flowrate of the refrigerant introduced to the second heat exchanger 140 may be controlled considering pressure of the second heat exchanger 140 such that carbon dioxide is sublimated or evaporated to a gas in the second heat exchanger 140).

At this time, the second gas discharge valve 194 is closed and the (2-1)th circulation valve 162 is opened. Also, a temperature of a carbon dioxide gas discharged through the second circulation pipe 160 may be greater than the temperature at which solid carbon dioxide is generated.

A portion of carbon dioxide frozen in the second heat exchanger 140 may be liquefied, and carbon dioxide liquid refined while being liquefied may be externally discharged through the second liquid discharge pipe 183 (at this time, the second liquid discharge valve 184 may be opened).

In the first thawing operation (S123), the target gas transferred to the second compressor 161 is reintroduced to the second heat exchanger 140 and the second heat exchanger 140 is thawed. The second compressor 161 compresses the target gas, and a temperature of the target gas compressed through the second compressor 161 is increased.

The target gas having the increased temperature through the second compressor 161 is reintroduced to the second heat exchanger 140, and the target gas having the increased temperature may thaw the target gas frozen in the second heat exchanger 140. In other words, the target gas reintroduced to the second heat exchanger 140 through the second compressor 161 is used as a sweep gas, and thaws the target gas frozen in the second heat exchanger 140.

The target gas thawed in the second heat exchanger 140 may circulate by being supplied to the second compressor 161 and the second heat exchanger 140 through the second circulation pipe 160.

In detail, when the target gas is carbon dioxide, carbon dioxide having the increased temperature through the second compressor 161 may be reintroduced to the second heat exchanger 140, and carbon dioxide reintroduced to the second heat exchanger 140 is used as the sweep gas to thaw carbon dioxide frozen in the second heat exchanger 140. (At this time, the (2-2)th circulation valve 163 may be opened and the (1-2)th circulation valve 133 may be closed).

Carbon dioxide thawed in the second heat exchanger 140 may circulate by being supplied to the second compressor 161 and the second heat exchanger 140 through the second circulation pipe 160.

A gas discharge pipe 195 for externally discharging the target gas may be connected to the second circulation pipe 160, and the target gas transferred through the second circulation pipe 160 may be externally discharged through the gas discharge pipe 195. In other words, refined gas carbon dioxide transferred through the second circulation pipe 160 may be externally discharged through the gas discharge pipe 195.

In the first process operation (S120), the first freezing operation (S121) may be performed in the first heat exchanger 110, and the first transfer operation (S122) and the first thawing operation (S123) may be performed in the second heat exchanger 140.

According to an embodiment of the disclosure, the first freezing operation (S121) of the first process operation (S120) may be simultaneously performed with the first transfer operation (S122) and first thawing operation (S123) of the first process operation (S120). In other words, the target gas may be frozen in the first heat exchanger 110 and the target gas may be thawed in the second heat exchanger 140.

The second process operation (S130) may be performed after the first process operation (S120). In the first process operation (S120), the target gas is frozen in the first heat exchanger 110 and the target gas is thawed in the second heat exchanger 140. As opposed to the first process operation (S120), in the second process operation (S130), the target gas is thawed in the first heat exchanger 110 and the target gas is frozen in the second heat exchanger 140.

In detail, the second process operation (S130) includes a second freezing operation (S131), a second transfer operation (S132), and a second thawing operation (S133).

In the second freezing operation (S131), the first gas inlet unit 120 is blocked and the inlet gas is introduced to the second heat exchanger 140 through the second gas inlet unit 150 so as to freeze the target gas in the second heat exchanger 140.

The inlet gas is introduced to the second gas inlet unit 150 by opening the second opening or closing valve 151 of the second gas inlet unit 150 and closing the first opening or closing valve 121 of the first gas inlet unit 120. At this time, the compressor 170 may or may not be connected to the first gas inlet unit 120 and the second gas inlet unit 150.

The refrigerant may be supplied to the second heat exchanger 140, and the target gas among the inlet gas introduced to the second heat exchanger 140 is cooled down to be frozen through the refrigerant.

When the target gas is carbon dioxide, the inlet gas is cooled down in the second heat exchanger 140 at a temperature at which solid carbon dioxide is generated, considering the carbon dioxide phase equilibrium diagram of FIG. 4.

In detail, considering the pressure inside the second heat exchanger 140, the inlet gas of the second heat exchanger 140 is cooled down through the refrigerant such that solid carbon dioxide is generated in the second heat exchanger 140.

When carbon dioxide is frozen in the second heat exchanger 140, the noncondensable gas from which carbon dioxide has been removed may be externally discharged through the second circulation pipe 160 and second gas discharge pipe 193.

At this time, the second gas discharge valve 194 is opened and the (2-1)th circulation valve 162 is closed. Also, the temperature of the noncondensable gas discharged through the second gas discharge pipe 193 may be equal to or lower than the temperature at which solid carbon dioxide is generated.

In the second transfer operation (S132), the target gas frozen in the first heat exchanger 110 is sublimated or evaporated, and transferred to the first compressor 131 of the first circulation pipe 130. The freezing has occurred in the first heat exchanger 110 during the first process operation (S120), and thus the target gas is frozen in the first heat exchanger 110.

In the second transfer operation (S132), the target gas frozen in the first heat exchanger 110 is sublimated or evaporated (or liquefied) through the refrigerant, and the target gas sublimated or evaporated in the second transfer operation (S132) may be transferred to the first compressor 131 through the first circulation pipe 130.

In detail, when the target gas is carbon dioxide, carbon dioxide frozen in the first heat exchanger 110 may be sublimated or evaporated by the refrigerant, and sublimated or evaporated carbon dioxide may be transferred to the first compressor 131 through the first circulation pipe 130. (The temperature and flowrate of the refrigerant introduced to the first heat exchanger 110 may be controlled considering pressure of the first heat exchanger 110 such that carbon dioxide is sublimated or evaporated to a gas in the first heat exchanger 110).

At this time, the first gas discharge valve 192 is closed and the (1-1)th circulation valve 132 is opened. Also, a temperature of a carbon dioxide gas discharged through the first circulation pipe 130 may be greater than the temperature at which solid carbon dioxide is generated.

Also, a portion of carbon dioxide frozen in the first heat exchanger 110 may be liquefied, and carbon dioxide liquid refined while being liquefied may be externally discharged through the first liquid discharge pipe 181 (at this time, the first liquid discharge valve 182 may be opened).

In the second thawing operation (S133), the target gas transferred to the first compressor 131 is reintroduced to the first heat exchanger 110 and the first heat exchanger 110 is thawed. The first compressor 131 compresses the target gas, and a temperature of the target gas compressed through the first compressor 131 is increased.

The target gas having the increased temperature through the first compressor 131 is reintroduced to the first heat exchanger 110, and the target gas having the increased temperature may thaw the target gas frozen in the first heat exchanger 110. In other words, the target gas reintroduced to the first heat exchanger 110 through the first compressor 131 is used as a sweep gas, and thaws the target gas frozen in the first heat exchanger 110.

The target gas thawed in the first heat exchanger 110 may circulate by being supplied to the first compressor 131 and the first heat exchanger 110 through the first circulation pipe 130.

In detail, when the target gas is carbon dioxide, carbon dioxide having the increased temperature through the first compressor 131 may be reintroduced to the first heat exchanger 110, and carbon dioxide reintroduced to the first heat exchanger 110 is used as the sweep gas to thaw carbon dioxide frozen in the first heat exchanger 110. (At this time, the (1-2)th circulation valve 133 may be opened and the (2-2)th circulation valve 163 may be closed.)

Carbon dioxide thawed in the first heat exchanger 110 may circulate by being supplied to the first compressor 131 and the first heat exchanger 110 through the first circulation pipe 130.

The gas discharge pipe 195 for externally discharging the target gas may be connected to the first circulation pipe 130, and the target gas transferred through the first circulation pipe 130 may be externally discharged through the gas discharge pipe 195. In other words, refined gas carbon dioxide transferred through the first circulation pipe 130 may be externally discharged through the gas discharge pipe 195.

In detail, the target gas is frozen as the inlet gas is introduced to the first heat exchanger 110, and the noncondensable gas from which the target gas has been removed is discharged to the first gas discharge pipe 191. While the noncondensable gas from which the target gas has been removed is discharged to the first gas discharge pipe 191, the target gas sublimated or evaporated in the second heat exchanger 140 circulates through the second circulation pipe 160 and the second compressor 161 to thaw the target gas frozen in the second heat exchanger 140, and at this time, liquid is discharged through the second liquid discharge pipe 183 and a sublimated or evaporated gas is discharged through the gas discharge pipe 195.

When the thawing in the second heat exchanger 140 is completed, the inlet gas is introduced to the second heat exchanger 140 and the target gas is frozen, and the noncondensable gas from which the target gas has been removed is discharged to the second gas discharge pipe 193. While the noncondensable gas from which the target gas has been removed is discharged to the second gas discharge pipe 193, the target gas sublimated or evaporated in the first heat exchanger 110 circulates through the first circulation pipe 130 and the first compressor 131 to thaw the target gas frozen in the first heat exchanger 110, and at this time, liquid is discharged through the first liquid discharge pipe 181 and a sublimated or evaporated gas is discharged through the gas discharge pipe 195.

In the second process operation (S130), the second freezing operation (S131) may be performed in the second heat exchanger 140, and the second transfer operation (S132) and the second thawing operation (S133) may be performed in the first heat exchanger 110.

According to an embodiment of the disclosure, the second freezing operation (S131) of the second process operation (S130) may be simultaneously performed with the second transfer operation (S132) and second thawing operation (S133) of the second process operation (S130). In other words, the target gas may be frozen in the second heat exchanger 140 and the target gas may be thawed in the first heat exchanger 110.

According to an embodiment of the disclosure, the second process operation (S130) may be performed for a specified time after the first process operation (S120) is performed for a specified time. Also, the first process operation (S120) may be performed again after the second process operation (S130) is performed, and the first process operation (S120) and the second process operation (S130) may be alternately performed.

Here, the times of performing the first process operation (S120) and second process operation (S130) may be the same as or different from each other. According to an embodiment of the disclosure, the times of performing the first process operation (S120) and second process operation (S130) may vary according to a heat exchange area of the first heat exchanger 110 and a heat exchange area of the second heat exchanger 140.

When the first process operation (S120) and the second process operation (S130) are alternately performed as such, the target gas is repeatedly frozen and thawed in the first heat exchanger 110 and the second heat exchanger 140.

In detail, in the first process operation (S120), the target gas is frozen in the first heat exchanger 110 and thawed in the second heat exchanger 140, and in the second process operation (S130), the target gas is frozen in the second heat exchanger 140 and thawed in the first heat exchanger 110.

The gas separation method using a deep cooling process, according to an embodiment of the disclosure, repeatedly performs the first process operation (S120) and the second process operation (S130) so that the target gas is repeatedly frozen and thawed in the first heat exchanger 110 and the second heat exchanger 140, and thus a mechanical apparatus may not be used to remove the frozen target gas.

Accordingly, a mechanical failure may be prevented during the gas separation method using a deep cooling process, according to an embodiment of the disclosure.

Also, the gas separation method using a deep cooling process, according to an embodiment of the disclosure, may efficiently separate the target gas because a separate gas is not required to be used, by thawing the frozen target gas by using a process gas present in the deep cooling process as a sweep gas.

The gas separation method using a deep cooling process, according to an embodiment of the disclosure, has following effects.

The gas separation method using a deep cooling process, according to an embodiment of the disclosure, may separate a target gas from a natural gas, flue gas, or synthetic gas, by repeatedly freezing and thawing a first heat exchanger and a second heat exchanger during the deep cooling process.

Also, the gas separation method using a deep cooling process, according to an embodiment of the disclosure, repeatedly freezes and thaws the target gas in the first heat exchanger and the second heat exchanger and thus may not use a mechanical apparatus to remove the frozen target gas, and accordingly, a mechanical failure may be prevented.

In addition, the gas separation method using a deep cooling process, according to an embodiment of the disclosure, may efficiently separate the target gas because a separate gas is not required to be used, by thawing the frozen target gas by using a process gas present in the deep cooling process as a sweep gas.

Furthermore, the gas separation method using a deep cooling process, according to an embodiment of the disclosure, may separate the target gas in a liquid or gas state, by repeatedly freezing and thawing the first heat exchanger and the second heat exchanger during the deep cooling process.

The disclosure relates to the gas separation method using a deep cooling process, wherein the target gas can be separated from a natural gas, flue gas, or synthetic gas, by repeatedly freezing and thawing the first heat exchanger and the second heat exchanger during the deep cooling process.

Also, in the disclosure, the target gas can be separated in a liquid or gas form by repeatedly freezing and thawing the first heat exchanger and the second heat exchanger during the deep cooling process.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of separating a gas through a gas separation apparatus for separating a gas by using a deep cooling process,
wherein the gas separation apparatus comprises:
a first heat exchanger for cooling an inlet gas, a first gas inlet unit connected to the first heat exchanger and introducing the inlet gas to the first heat exchanger, and a first circulation pipe for reintroducing a gas discharged from the first heat exchanger to the first heat exchanger and including a first compressor; and
a second heat exchanger for cooling the inlet gas, a second gas inlet unit connected to the second heat exchanger and introducing the inlet gas to the second heat exchanger, and a second circulation pipe for reintroducing a gas discharged from the second heat exchanger to the second heat exchanger and including a second compressor,
the method comprising:
a first process operation including: a first freezing operation of blocking the second gas inlet unit, introducing the inlet gas to the first heat exchanger through the first gas inlet unit, and freezing a target gas in the first heat exchanger; a first transfer operation of sublimating or evaporating the frozen target gas in the second heat exchanger and transferring the same to the second compressor of the second circulation pipe; and a first thawing operation of reintroducing the target gas transferred to the second compressor to the second heat exchanger and thawing the second heat exchanger; and
a second process operation including: a second freezing operation of blocking the first gas inlet unit, introducing the inlet gas to the second heat exchanger through the second gas inlet unit, and freezing the target gas in the second heat exchanger; a second transfer operation of sublimating or evaporating the frozen target gas in the first heat exchanger and transferring the same to the first compressor of the first circulation pipe; and a second thawing operation of reintroducing the target gas transferred to the first compressor to the first heat exchanger and thawing the first heat exchanger,
wherein the first process operation is performed for a specified time and then the second process operation is performed for a specified time.

2. The method of claim 1, wherein the first process operation is performed again after the second process operation is performed, and
the first process operation and the second process operation are alternately performed.

3. The method of claim 1, wherein the target gas is a sublimating gas.

4. The method of claim 1, wherein the target gas is carbon dioxide.

5. The method of claim 1, wherein the first gas inlet unit and the second gas inlet unit are connected to a compressor.

6. The method of claim 1, wherein the first circulation pipe and the second circulation pipe are connected to each other, and the first compressor and the second compressor configure one compressor.

7. The method of claim 1, wherein a first opening or closing valve for opening or closing the first gas inlet unit is provided at the first gas inlet unit, and
a second opening or closing valve for opening or closing the second gas inlet unit is provided at the second gas inlet unit.

8. The method of claim 1, wherein the first circulation pipe includes a (1-1)th circulation valve for opening or closing the first circulation pipe at a front end of the first compressor, and a (1-2)th circulation valve for opening or closing the first circulation pipe at a rear end of the first compressor, and
the second circulation pipe includes a (2-1)th circulation valve for opening or closing the second circulation pipe at a front end of the second compressor, and a (2-2)th circulation valve for opening or closing the second circulation pipe at a rear end of the second compressor.
